(19) United States
(12) Patent Application Publication
(10) Pub. No.: US 2025/0155289 A1
(43) Pub. Date: May 15, 2025

(54) INFORMATION PROCESSING APPARATUS, METHOD OF CONTROLLING THE SAME, AND STORAGE MEDIUM

(71) Applicant: CANON KABUSHIKI KAISHA, Tokyo (JP)

(72) Inventor: KIMIO HAYASHI, Tokyo (JP)

(21) Appl. No.: 18/938,934

(22) Filed: Nov. 6, 2024

(30) Foreign Application Priority Data
Nov. 10, 2023 (JP) 2023-192282

(51) Int. Cl. G01J 3/52

(52) U.S. Cl. CPC G01J 3/52

(57) ABSTRACT

A method of controlling an information processing apparatus includes acquiring reference values of patches of a color chart and information on layout of the patches, acquiring colorimetric values obtained by performing colorimetry on the color chart by a spectrophotometer, and specifying a row of the color chart on which a user has performed colorimetry based on the acquired reference values of the patches, the acquired information on the layout of the patches, and the acquired colorimetric values.

### BACKGROUND

### Field

The present disclosure relates to an information processing apparatus performing colorimetry on a color chart.

### Description of the Related Art

A commercial printed document such as a catalog and a brochure is subjected to color management before printing. The color management includes, for example, color verification in which colorimetry is performed on a color chart output from a printing apparatus, and an actual output result (colorimetric values) and set guideline (reference values) are compared. The color management further includes calibration for adjusting colors and color shift in a case where it is determined by the color verification that color shift is present or in a case where desired colors cannot be obtained in color printing.

In the color verification, a spectrophotometer performs colorimetry on a color chart output from an image forming apparatus, and a color output state of the image forming apparatus is actually measured. The color chart is a printed document in which a plurality of color patches is arranged, and mixed degrees of ink/toner of colors such as cyan, magenta, yellow, and black (CMYK) and various width patterns of lines are integrated in order to check a printing condition of the image forming apparatus. For example, a user sequentially performs colorimetry on the color patches of the color chart row by row.

Japanese Patent Application Laid-Open No. 2015-152552 discusses a method in which, while the user performs colorimetry on the color patches arranged in the same row, when colorimetry is performed on a color patch in the other row due to operation mistake by the user, a notification is issued to the user.

In a related art, in a case where colorimetry is performed on a color chart, a user selects a row or a column to be subjected to colorimetry by using an input device such as a mouse on a screen, and then, the user replaces the input device with the spectrophotometer to perform colorimetry on the selected row. In this case, replacement of the spectrophotometer and the input device occurs every time the colorimetry is performed, and usability is low.

### SUMMARY

The present disclosure is directed to a color chart colorimetry method with high usability.

According to some embodiments, a method of controlling an information processing apparatus includes acquiring reference values of patches of a color chart and information on layout of the patches, acquiring colorimetric values obtained by performing colorimetry on the color chart by a spectrophotometer, and specifying a row of the color chart on which a user has performed colorimetry based on the acquired reference values of the patches, the acquired information on the layout of the patches, and the acquired colorimetric values.

Further features of the present disclosure will become apparent from the following description of exemplary embodiments with reference to the attached drawings.

### BRIEF DESCRIPTION OF THE DRAWINGS

FIG. 1 is a block diagram illustrating an entire system according to a first exemplary embodiment.

FIG. 2 is a hardware configuration diagram of an information processing apparatus according to the first exemplary embodiment.

FIG. 3 is a functional block diagram of the system according to the first exemplary embodiment.

FIG. 4 illustrates an example of a colorimetry screen according to the first exemplary embodiment.

FIG. 5 illustrates examples of setting values according to the first exemplary embodiment.

FIG. 6 illustrates an example of a color chart according to the first exemplary embodiment.

FIG. 7 illustrates examples of colorimetric values according to the first exemplary embodiment.

FIG. 8 illustrates an example of a colorimetric result according to the first exemplary embodiment.

FIG. 9 is a flowchart illustrating a flow of row determination according to the first exemplary embodiment.

FIG. 10 illustrates an example of a color chart according to a second exemplary embodiment.

FIG. 11 is a flowchart for acquiring setting values according to the second exemplary embodiment.

FIG. 12 illustrates examples of colorimetric values according to a third exemplary embodiment.

FIG. 13 is a flowchart for specifying colorimetric values according to the third exemplary embodiment.

FIG. 14 is a flowchart for checking a distinction patch according to a fourth exemplary embodiment.

FIG. 15 is a flowchart for checking a special patch according to a fifth exemplary embodiment.

### DESCRIPTION OF THE EMBODIMENTS

Various exemplary embodiments, features, and aspects of the present disclosure will be described with reference to the drawings. Color management is roughly divided into a step of printing a color chart by an image forming apparatus, a step of performing colorimetry on the printed color chart by a spectrophotometer, a step of comparing colorimetric values acquired by colorimetry with reference values, and a step of performing color processing (such as calibration). The exemplary embodiments are assumed to be used in the step of performing colorimetry on the color chart. The following exemplary embodiments do not limit the disclosure according to the claims, and all of combinations of features described in the exemplary embodiments are not necessarily essential for solving means of the disclosure.

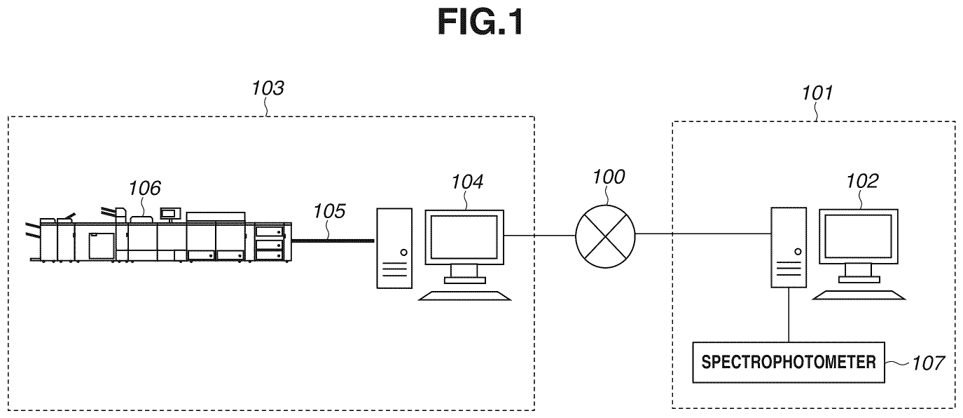

A first exemplary embodiment is described. FIG. 1 is a block diagram illustrating a configuration of a system including a computer according to the present exemplary embodiment. It goes without saying that the present exemplary embodiment is applicable to even a single apparatus or a system including a plurality of apparatuses as long as functions of the present exemplary embodiment are executed. It goes without saying that the present exemplary embodiment is applicable even to a system in which apparatuses are connected through a network such as a local area network (LAN) and a wide area network (WAN) and mutually perform processing.

The system is roughly divided into a colorimetry system 101 and a color management system 103 that are mutually connected through Internet 100.

The colorimetry system 101 includes an information processing apparatus 102 and a spectrophotometer 107. The colorimetry system 101 is assumed to have an on-premise configuration. However, the colorimetry system 101 may have a cloud configuration as long as the present exemplary embodiment can be realized. The information processing apparatus 102 is an apparatus that mutually communicates with the spectrophotometer 107 and performs processing relating to colorimetry. The spectrophotometer 107 is an apparatus performing colorimetry on a color chart, and may be a manual spectrophotometer or an automatic spectrophotometer.

The color management system 103 includes an information processing apparatus 104 and an image forming apparatus 106 that are mutually connected through a network 105. An application operating on the information processing apparatus 104 is mainly referred to as a print controller, and controls the image forming apparatus 106. The image forming apparatus 106 is controlled under programs operating on the information processing apparatus 104, processes print setting and print data received from the information processing apparatus 104, and outputs a printed document. The following description is given while the information processing apparatuses described above are assumed to be computers (PC), but each of the information processing apparatuses may be a smartphone, a tablet, or other information processing apparatus.

Color verification is performed by the above-described system. More specifically, a user performs various kinds of settings of, for example, reference values of colorimetry, the image forming apparatus performing the color verification, and the colorimetry. Subsequently, the user instructs the image forming apparatus to print a color chart. The color chart printed at this time reflects the above-described settings. Thereafter, the user performs colorimetry on the output color chart by using the spectrophotometer 107. The color management system 103 verifies color output of the image forming apparatus by comparing values obtained by the colorimetry and the set reference values. In a case where differences between colorimetric values and the reference values are large, an error is notified, and the user performs a work such as calibration of the image forming apparatus.

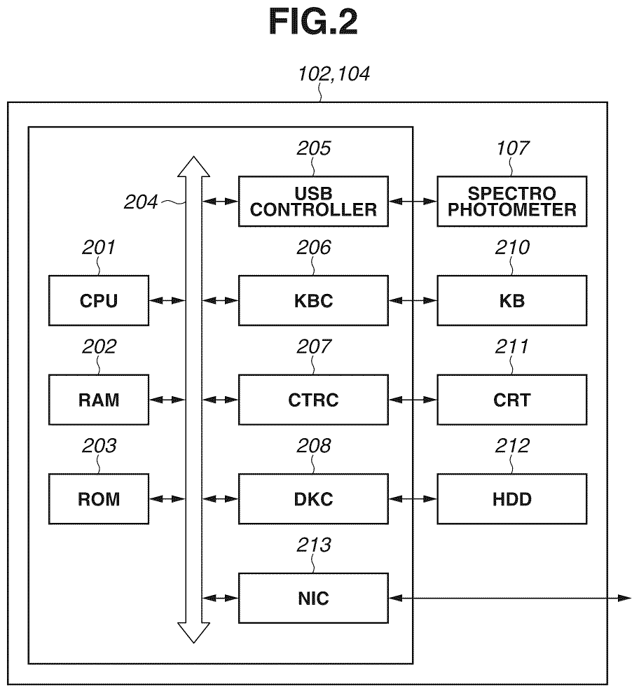

FIG. 2 is a block diagram illustrating a hardware configuration of the information processing apparatuses 102 and 104.

In FIG. 2, a central processing unit (CPU) 201 may include one or more processors and executes an operating system (OS) and programs of general applications stored in a read only memory (ROM) 203 or loaded from a hard disk drive (HDD) 212 to a random access memory (RAM) 202. The RAM 202 functions as a main memory, a work area, and the like for the CPU 201. A universal serial bus (USB) controller 205 outputs an instruction to the spectrophotometer 107 and receives colorimetric values from the spectrophotometer 107. A keyboard controller (KBC) 206 controls inputs from a keyboard (KB) 210 and a pointing device (not illustrated). A display controller (CRTC) 207 controls display of a display unit (CRT) 211. A disk controller (DKC) 208 has a function of communicating with the HDD 212 and the like storing a boot program, various applications, font data, and the like. A network controller (NIC) 213 is connected to a network, and performs communication control processing with another apparatus connected to the network. A bus 204 connects the CPU 201, the RAM 202, the ROM 203, various kinds of controllers, and the like to transmit data signals and control signals.

In a case of a mobile phone, the mobile phone may include a touch panel controller or the like in place of the keyboard controller (KBC) 206. An internal configuration of the network controller 213 depends on a case where the apparatus supports a wired LAN or a wireless LAN, or a case where the apparatus supports both of the LANs. Differences of the internal configuration are concealed in the network controller (NIC) 213, and the network controller (NIC) 213 is equivalently configured relative to other modules illustrated in FIG. 2 to control the system.

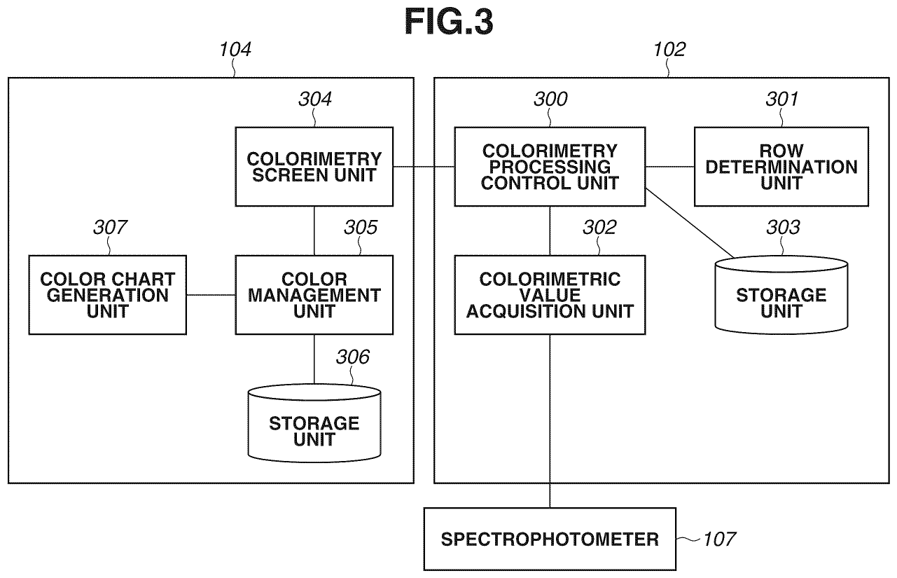

FIG. 3 is a functional block diagram of the system according to the present exemplary embodiment. The information processing apparatus 102 includes a colorimetry processing control unit 300, a row determination unit 301, a colorimetric value acquisition unit 302, and a storage unit 303. The information processing apparatus 104 includes a colorimetry screen unit 304, a color management unit 305, a storage unit 306, and a color chart generation unit 307. However, the configurations are not limited to these examples. The functional units operate when the CPU 201 executes the programs held in the ROM 203 and the HDD 212.

The colorimetry processing control unit 300 controls various kinds of colorimetry processing by communicating with the color management unit 305 through the colorimetry screen unit 304.

The row determination unit 301 receives setting values and colorimetric values from the colorimetry processing control unit 300 and determines whether each of the colorimetric values correspond to which row in the color chart. As details are described below, the setting values include information on reference values of respective patches of the color chart, and the number of pages, the number of rows, and the number of columns of the color chart. The setting values may be stored in the storage unit 303, or may be stored in the storage unit 306 and acquired through the colorimetry screen unit 304. The row determination unit 301 may be provided in the information processing apparatus 104.

The colorimetric value acquisition unit 302 communicates with the spectrophotometer 107, instructs the spectrophotometer 107 to perform colorimetry, and receives the colorimetric values from the spectrophotometer 107.

The storage unit 303 holds setting values for colorimetry processing.

The colorimetry screen unit 304 provides screens relating to colorimetry of the color chart using the spectrophotometer 107. The colorimetry screen unit 304 provides, for example, an image imitating the color chart, a screen indicating a portion of the color chart on which the colorimetry has been performed, and a screen indicating a result of the colorimetry. The information processing apparatus 102 displays the screens provided by the colorimetry screen unit 304 by using a web browser.

The color management unit 305 manages processing for color management such as calibration and profile creation performed by the information processing apparatus 104. The color management unit 305 instructs the image forming apparatus 106 to print a color chart for the color management.

The storage unit 306 holds setting values of the color management unit 305.

The color chart generation unit 307 generates a color chart in response to an instruction from the color management unit 305. Information on the generated color chart (reference values of respective patches, number of pages, number of rows, and number of columns of color chart) is stored in the storage units 303 and 306, and is used when color verification is performed.

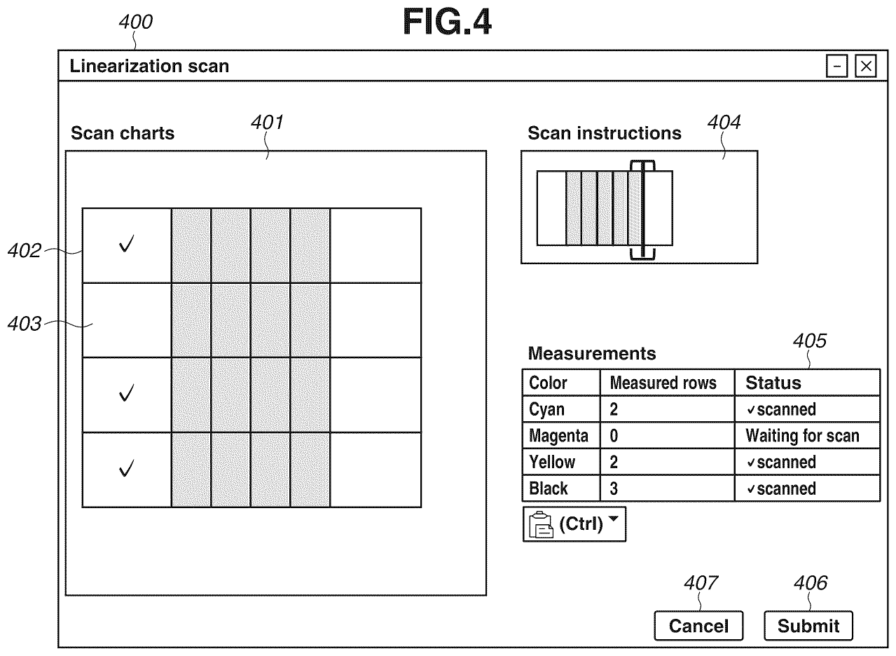

FIG. 4 is a schematic diagram illustrating an example of a colorimetry screen that is provided by the colorimetry screen unit 304 and is displayed by the information processing apparatus 102. A colorimetry screen 400 is an example of a remote user interface of the print controller operating on the information processing apparatus 104. The colorimetry screen 400 can be opened by designating a uniform resource locator (URL) of the printer controller on the browser.

The colorimetry screen 400 includes a field of a color chart colorimetry state 401, a field of a scan instruction 404, a field of a colorimetry state 405, a submit button 406, and a cancel button 407.

In the field of the color chart colorimetry state 401, an image imitating the color chart and icons corresponding to colorimetry states of the respective rows are displayed. For example, the icons include a colorimetry completed icon 402 and a colorimetry unexecuted icon 403. As illustrated, the color chart includes color patches arranged in a predetermined number of rows and a predetermined number of columns, and the color patches have different colors.

Immediately after start of colorimetry of the color chart, colorimetry has been performed on none of the rows. Accordingly, the colorimetry unexecuted icon 403 is displayed for all of the rows. When colorimetry of a predetermined row is completed, the state of the row is changed to a colorimetry completed state, and the displayed icon is changed from the colorimetry unexecuted icon 403 to the colorimetry completed icon 402. In a case where the colorimetry is performed on the same row many times, the number of times of colorimetry in the colorimetry state 405 described below is increased while the colorimetry completed icon 402 is displayed.

The field of the scan instruction 404 presents, to the user, that the user slides the spectrophotometer 107 on the color chart output by the image forming apparatus 106 to perform colorimetry on a predetermined row of the color chart. A bar indicating movement of the spectrophotometer 107 from a right side to a left side of the predetermined row or from the left side to the right side of the predetermined row is displayed.

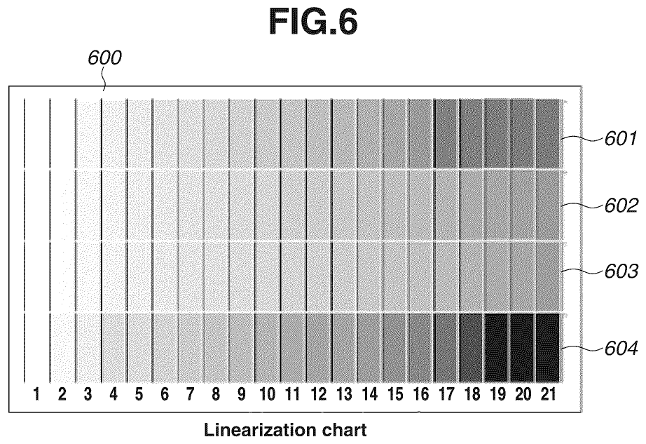

The colorimetry state 405 displays the number of times of colorimetry and the colorimetry state of each of the rows of the color chart. For example, the color chart illustrated in FIG. 6 includes four rows of cyan, magenta, yellow, and black. For example, when colorimetry is performed on the row of black, the number of times of colorimetry corresponding to the row of black is increased. In a case where colorimetry is performed on a row in which the displayed colorimetry state indicates a colorimetry unexecuted state (e.g., waiting for scan), the displayed colorimetry state of the corresponding row is changed to the colorimetry state indicating the colorimetry completed state (scanned).

In a case where the submit button 406 is pressed, the colorimetry processing is completed, and a colorimetric result is transmitted to the color management unit 305.

In a case where the cancel button 407 is pressed, the colorimetry processing is canceled.

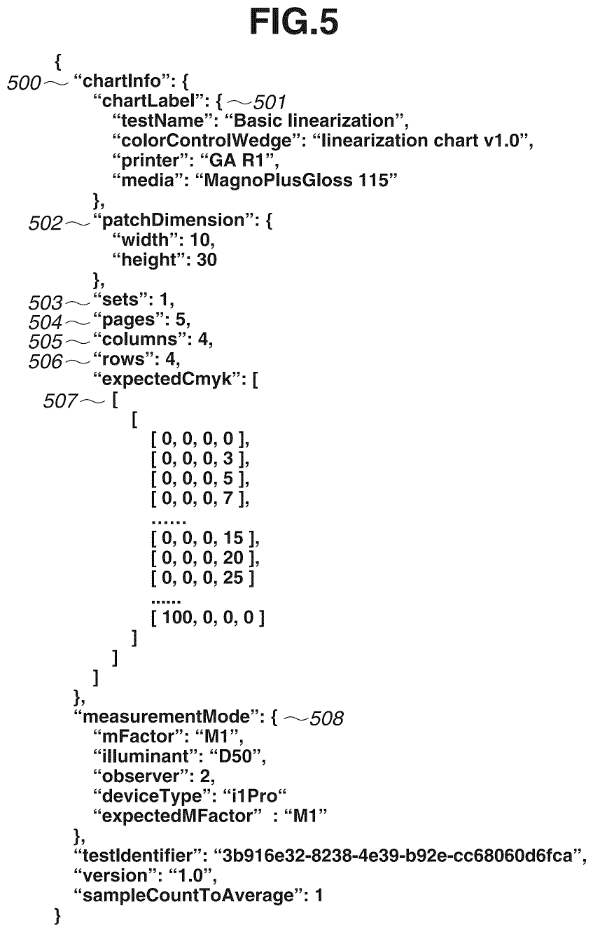

FIG. 5 illustrates examples of setting values used for the colorimetry processing. The setting values include information on the reference values of the respective patches of the color chart, the number of pages of the color chart, the number of rows of the color chart, and the number of columns of the color chart. The setting values are uniquely determined when the user selects the color chart to be used, selects the image forming apparatus, performs setting of the colorimetry, and the like. The setting values are stored in, for example, the storage units 303 and 306, and are acquired based on selection by the user.

A reference numeral 500 indicates the setting values. The setting values correspond to a color chart 600 illustrated in FIG. 6 and include data for the colorimetry processing.

FIG. 5 illustrates metadata 501 on the color chart. The metadata 501 on the color chart includes, for example, a color chart name, a color standard specification of the color chart, a name of a printer printing the color chart, and a name of a sheet used when the color chart is printed. FIG. 5 illustrates a height and a width 502 as a size of the color chart, the number of sets of the color chart 503, the number of pages of the color chart 504, the number of columns in one page of the color chart 505, and the number of rows in one page of the color chart 506.

In the present exemplary embodiment, arrangement of the patches represented by the number of columns 505 and the number of rows 506 is referred to as patch layout. The arrangement (layout) of the patches of the color chart can be grasped from the number of columns 505 and the number of rows 506.

FIG. 5 illustrates reference values 507 of the respective color patches in one page of the color chart. In a case where the color chart spreads over a plurality of pages, a plurality of reference values 507 is present. At initialization of the colorimetry processing, the reference values are arranged based on the number of columns 505 and the number of rows 506 to create a matrix as with the following tables. Here, an example in which a first page of the color chart includes the layout of 4×4 patches, and a second page also includes the layout of 4×4 patches. A value of each cell is represented by, for example, a configuration of “value of black, value of yellow, value of magenta, value of cyan”, but is not limited to the example. The value of each cell may be represented by RGB values or other values.

TABLE 1
First Page

| | First | Second | Third | Fourth |
|---|---|---|---|---|
| | Column | Column | Column | Column |
| First Row | 0, 0, 0, 0 | 0, 0, 0, 3 | 0, 0, 0, 5 | 0, 0, 0, 7 |
| Second Row | 0, 0, 0, 0 | 0, 0, 3, 0 | 0, 0, 5, 0 | 0, 0, 7, 0 |
| Third Row | 0, 0, 0, 0 | 0, 3, 0, 0 | 0, 5, 0, 0 | 0, 7, 0, 0 |
| Fourth Row | 0, 0, 0, 0 | 3, 0, 0, 0 | 5, 0, 0, 0 | 7, 0, 0, 0 |

TABLE 2
Second Page

| | First | Second | Third | Fourth |
|---|---|---|---|---|
| | Column | Column | Column | Column |
| First Row | 0, 0, 0, 15 | 0, 0, 0, 20 | 0, 0, 0, 25 | 0, 0, 0, 30 |
| Second Row | 0, 0, 15, 0 | 0, 0, 20, 0 | 0, 0, 25, 0 | 0, 0, 30, 0 |
| Third Row | 0, 15, 0, 0 | 0, 20, 0,0 | 0, 25, 0, 0 | 0, 30, 0, 0 |
| Fourth Row | 15, 0, 0, 0 | 20, 0, 0, 0 | 25, 0, 0, 0 | 30, 0, 0, 0 |

The reference value 507 includes groups of respective predetermined ranges. For example, the reference value 507 includes a group of such values that a value is increased by two every increase of the column, like 3, 5, and 7 (first page of color chart), and a group of such values that a value is increased by five every increase of the column, like 15, 20, and 25 (second page of color chart). In the present exemplary embodiment, for example, the value of 7 in the first row in the fourth column in the first page of the color chart is increased to 15 in the first row in the second page, and the value is increased by eight among the groups. When the groups of the reference values increased by a predetermined interval of a value are provided as described above, for example, even if color output of the image forming apparatus is entirely light, and the colorimetric value of one color patch is lower than the reference value, the interval of the colorimetric values of the plurality of color patches in one row is the predetermined interval of the value, which enables grasping of the row. Since the value of the interval is different among the groups, the groups can be distinguished from each other.

FIG. 5 illustrates various kinds of values 508 of a colorimetry mode. The values of the colorimetry mode include, for example, mFactor, an illuminant, and a visual field set to the spectrophotometer 107, a model of the spectrophotometer, and mFactor supposed for the reference values. Here, mFactor is a standard of International Organization for Standardization (ISO) and indicates a measurement illumination condition.

FIG. 6 illustrates an example of the color chart. The color chart 600 is generated by the information processing apparatus 104 and printed by the image forming apparatus 106. The color chart 600 includes four rows 601, 602, 603, and 604. The row 601 is a row where only cyan is used, the row 602 is a row where only magenta is used, the row 603 is a row where only yellow is used, and the row 604 is a row where only black is used. One of color components CMYK is used in one of the rows 601 to 604 to enable secure distinction of the rows. Each of the rows is configured such that the corresponding color becomes gradually dark toward a right side. In this example, each of the rows includes 21 columns, but the description is given by assuming that each of the rows includes four columns as described above, for simplification of the description.

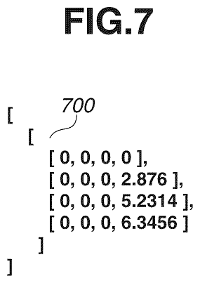

FIG. 7 illustrates examples of the colorimetric values acquired by performing colorimetry on an optional row of the color chart by the spectrophotometer 107. The colorimetric values are acquired by the colorimetric value acquisition unit 302 and are notified to the color management unit 305. When the colorimetry is performed on a predetermined row of the color chart by the spectrophotometer 107, the spectrophotometer 107 acquires colorimetric values corresponding to the respective color patches in the predetermined row of the color chart. The colorimetric values are returned to the colorimetric value acquisition unit 302 as data in any of formats of RGB, CMYK, and LAB. The colorimetric value acquisition unit 302 creates the colorimetric values as illustrated in FIG. 7. In this example, the colorimetric values corresponding to the four color patches in one row are illustrated.

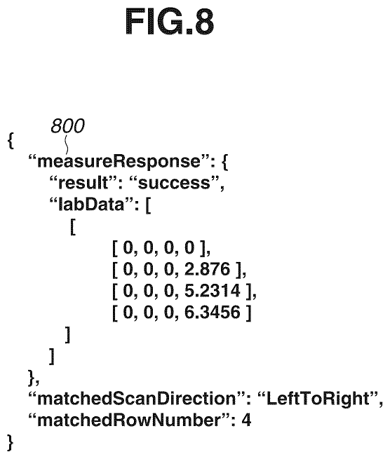

FIG. 8 illustrates an example of a colorimetric result generated by the colorimetry processing control unit 300 in a case where the row on which the colorimetry has been performed is specified by the row determination unit 301. A colorimetric result 800 includes information indicating success or failure of the colorimetry, information indicating success or failure of the row determination, the colorimetric values, a colorimetric direction, and a row number. For example, when differences between the colorimetric values and the reference values are within a predetermined range, the colorimetry is determined as success, whereas when the differences are out of the predetermined range, the colorimetry is determined as failure. The colorimetric result 800 is notified to the color management unit 305.

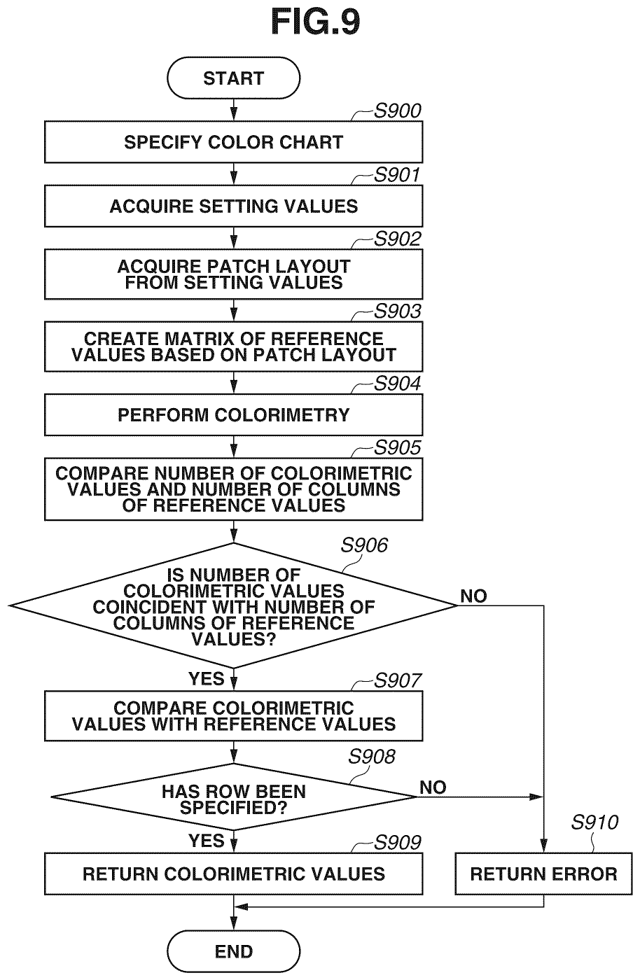

FIG. 9 is a flowchart illustrating a flow from the colorimetry of the color chart to the row determination. After the color chart for color management processing such as color verification and calibration is printed, the processing in the flow chart is started in a case where a colorimetry start instruction is issued by a user on a screen (not illustrated). The following processing is performed by the CPU 201.

In step S900, the color management unit 305 specifies a color chart for color management. For example, to perform color verification targeting an industry color standard such as FOGRA and GRACOL, the color management unit 305 specifies a color chart of a designated color standard. Information on the specified color chart is notified to the colorimetry processing control unit 300 through the colorimetry screen unit 304. When the user performs various kinds of settings of the color verification and issues a print instruction, the color chart reflecting the various kinds of settings is printed by the image forming apparatus 106. In step S900, the information on the printed color chart is specified.

In step S901, the colorimetry processing control unit 300 acquires the setting values as illustrated in FIG. 5 corresponding to the color chart specified in step S900. The setting values are stored in the storage unit 303.

In step S902, the colorimetry processing control unit 300 acquires a patch layout from the setting values acquired in step S901.

In step S903, the colorimetry processing control unit 300 arranges the reference values included in the setting values based on the patch layout, to create a matrix of the reference values. In other words, the matrix of the reference value 507 illustrated in FIG. 5 is created.

In step S904, the user performs colorimetry on a predetermined row of the printed color chart by using the spectrophotometer. The colorimetric value acquisition unit 302 acquires the colorimetric values of the respective patches arranged in the predetermined row of the color chart. At this time, the colorimetric value acquisition unit 302 makes settings (e.g., colorimetry mode) for the colorimetry included in the setting values acquired in step S901, to the spectrophotometer 107. When the colorimetry of the row by the user is completed, the colorimetric values are acquired from the spectrophotometer 107. The user slides the spectrophotometer 107 on the predetermined row of the color chart and performs colorimetry on the color patches while pressing a predetermined button provided on the spectrophotometer 107. When the colorimetry of the predetermined row is completed, the user stops pressing of the predetermined button. It can be determined that one row of the color chart is formed of the color patches on which the colorimetry has been performed while the user presses the predetermined button. One colorimetric value can be acquired from one color patch.

In step S905, the colorimetry processing control unit 300 compares the number of colorimetric values acquired in step S904 and the number of columns of the matrix created in step S903.

In a case where the number of colorimetric values and the number of columns are coincident with each other in step S906 (YES in step S906), the processing proceeds to step S907. In a case where the number of colorimetric values and the number of columns are not coincident with each other (NO in step S906), the processing proceeds to step S910. In the examples illustrated in FIG. 5 and FIG. 7, the number of colorimetric values acquired in step S904 is four, and the number of columns of the matrix created in step S903 is four. Therefore, it is determined that the number of colorimetric values and the number of columns are coincident with each other.

In step S907, the row determination unit 301 compares the colorimetric values acquired in step S904 with each of the rows of the matrix of the reference values created in step S903. More specifically, in a case where one row includes four columns, there are four color patches. The acquired colorimetric values and each of the rows of the matrix of the reference values are compared in such a manner that the reference value of a first color patch is compared with a first colorimetric value, and the reference value of a second color patch is compared with a second colorimetric value, thereby specifying the row of the reference values similar to the colorimetric values. For example, differences between the reference values and the colorimetric values are determined for each row. It is determined that the row having the smallest total difference is the row on which the user has performed the colorimetry. An allowable value may be previously determined, and a row in which the difference between the colorimetric value and the reference value of each of the color patches is within the allowable value may be determined as the row on which the user has performed the colorimetry, or a row in which a total of differences between the colorimetric values and the reference values of the entire row is within the allowable value may be determined as the row on which the user has performed the colorimetry. The allowable value may be variably settable by the user. The method of specifying the row is illustrative, and the other method may be used as long as the row on which the user has performed the colorimetry is automatically determined.

In the above-described row determination, the row best matched after the colorimetry is performed on all columns of one row is determined as the row on which the user has performed the colorimetry, but the row may be determined in the middle of the colorimetry of one row. For example, in a case of the color chart illustrated in FIG. 6, the colors used in the respective rows are distinctively different from each other. Accordingly, the row on which the user has performed the colorimetry in the color chart may be determined at a time point when the colorimetry is performed on the first column. In a case where the row cannot be determined only from the colorimetric value of the first column, the row may be determined using the colorimetric values of predetermined columns. In a case where the row is determined in middle of the colorimetry, and the colorimetry is performed on a different row in middle of the colorimetry due to operation mistake by the user, a warning may be issued to the user. The colorimetric direction by the user is not limited to a direction from the left to the right of the color chart, and may be a direction from the right to the left. Accordingly, in consideration of the direction, the colorimetric values and the reference values may be associated in a reverse order and compared with each other, for example, a first colorimetric value is associated and compared with a fourth reference value, and a second colorimetric value is associated and compared with a third reference value. The direction of the colorimetry of the color chart performed by the user can be determined by the comparison.

In step S908, the colorimetry processing control unit 300 determines whether the row has been specified from the comparison between the colorimetric values and the reference values by the row determination unit 301. In a case where the row has been specified (YES in step S908), the processing proceeds to step S909. In a case where the row has not been specified (NO in step S908), the processing proceeds to step S910. For example, in a case where the differences between the colorimetric values and the respective reference values are each within the allowable value, it is determined that the row has been specified. In a case where the differences are each not within the allowable value, it is determined that the row has not been specified.

In step S909, the colorimetry processing control unit 300 transmits the colorimetric values acquired in step S904, and colorimetric result information indicating the row number of the row and the colorimetric direction specified in step S908, to the color management unit 305 through the colorimetry screen unit 304. In other words, the information illustrated in FIG. 8 is transmitted. In a case where the colorimetric result information is transmitted, the colorimetry completed icon 402 is displayed on the corresponding row in the screen illustrated in FIG. 4. In the field of the colorimetry state 405, the displayed colorimetry state is changed to the colorimetry state indicating the colorimetry completed state. In a case where the colorimetry is performed on the same row a plurality of times, the number of times of colorimetry in the field of the colorimetry state 405 is increased. In a case where the colorimetry processing is completed, the color management system 103 provides a screen for reporting a result of color verification.

In step S910, the colorimetry processing control unit 300 returns a row determination error to the colorimetry screen unit 304. The colorimetry screen unit 304 displays the row determination error. The colorimetry screen unit 304 may perform display indicating that the row has not been determined or display indicating that the number of colorimetric values and the number of columns of the color chart are not coincident with each other. In a case where the row having high possibility of colorimetry has been specified from the comparison in step S907, the display of the row may be changed.

With the above-described configuration, the row of the color chart on which the user has performed the colorimetry can be automatically determined without selection and instruction by the user. In the related art, in a case where the user performs colorimetry on a predetermined row of the color chart, the user first selects a row on which the colorimetry is to be performed on a colorimetry screen by using an input device such as a mouse. The user replaces the mouse with the spectrophotometer, and then performs the colorimetry on the selected row. In this case, replacement of the mouse and the spectrophotometer occurs every time the colorimetry is performed on the row, and usability is low. With the configuration according to the present exemplary embodiment, even when the user performs the colorimetry on the predetermined row of the color chart by using the spectrophotometer without operating the input device, the row on which the user has performed the colorimetry is automatically specified. For this reason, it is unnecessary for the user to select the row on which the colorimetry is to be performed, by the mouse or the like. In other words, the user can feely perform colorimetry of the color chart without performing complicated operation. For example, the user may perform colorimetry from any row of the color chart, may perform the colorimetry of the color chart in the direction from the right to the left in addition to the direction from the left to the right, and may perform colorimetry on the same row any number of times. Even in a case where the colorimetry is performed in any manner, it is possible to automatically specify the row on which the colorimetry has been performed, and to suitably recognize the colorimetric values.

A second exemplary embodiment is described. In the first exemplary embodiment, an example in which the setting values including the reference values and the patch layout are acquired from the storage unit 303 of the information processing apparatus 102 is described. However, there is a case where the reference values and the patch layout are made different depending on the image forming apparatus in which color verification is to be performed and a situation where the color verification is to be performed. In addition, there is a use case where the color management system creates a unique patch layout by using the same reference values. The reason why the unique layout is adopted is because, for example, a patch size greater than the patch size by a color standard is adopted to improve ease of colorimetry by the spectrophotometer. In addition, the unique layout is adopted in order to facilitate inspection of color unevenness by changing the arrangement of the patches and arranging the same type of colors at both ends of a sheet, or in order to facilitate inspection of color tone by arranging the same type of colors in gradation.

The second exemplary embodiment is described by using an example in which the setting values including the reference values and the patch layout are acquired from the color management system. In other words, an example in which a color chart and setting values suitable for a use case are generated, and colorimetry and determination of a row are performed is described. A basic configuration according to the second exemplary embodiment is the same as the basic configuration according to the first exemplary embodiment. Accordingly, only differences are described.

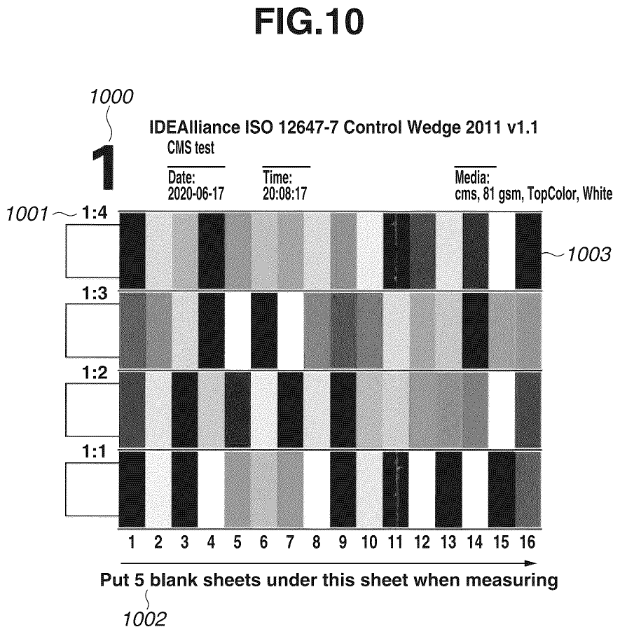

FIG. 10 illustrates an example of a color chart that is uniquely generated and held by the color management system 103.

A color chart 1000 complies with a color standard of IDEAlliance ISO 12647-7 Control Wedge2011, but has a unique layout. FIG. 10 illustrates a colorimetry order 1001 and a caution in colorimetry 1002. In the color chart 1000, a size of each of patches 1003 is greater than a size of each of patches in the color chart by the color standard. This is to prevent reading mistake of a row when the user manually performs colorimetry. In the color chart 1000, different colors are randomly arranged in each of the rows. There is a case where a patch layout in which any of colors CMYK is allocated to each of the rows to facilitate determination of a row is adopted, as illustrated in FIG. 6.

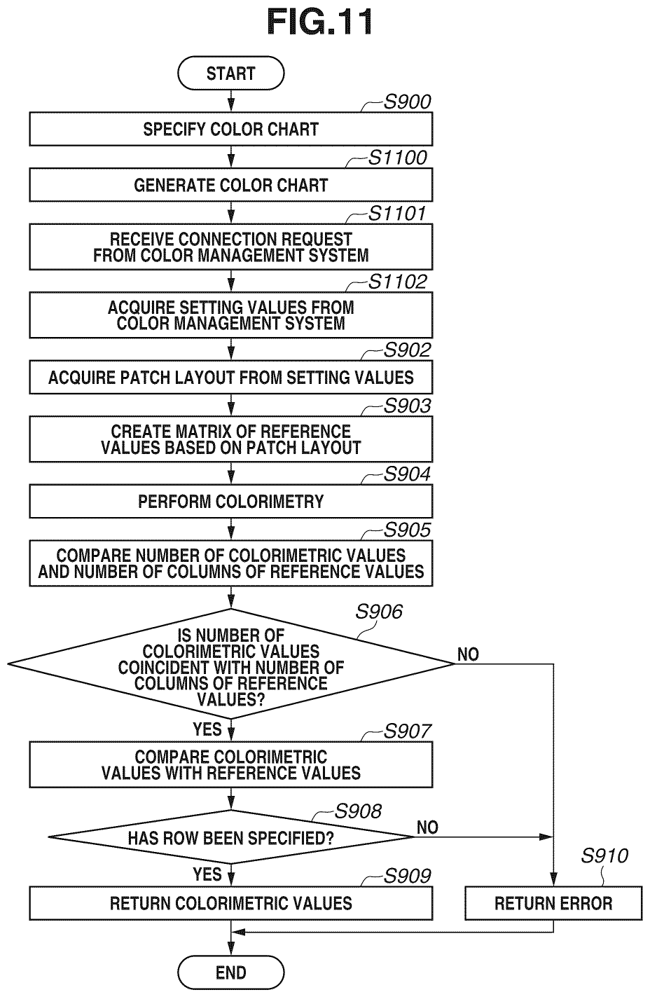

FIG. 11 is a flowchart illustrating a flow for acquiring the setting values from the color management system and performing colorimetry on the color chart and row determination. As in the first exemplary embodiment, the processing in the flowchart is started in a case where a colorimetry start instruction is issued by a user on a screen (not illustrated). The processing in the flowchart has the basic configuration same as the processing in the flowchart illustrated in FIG. 9. Accordingly, only differences are described.

In step S1100, the color chart generation unit 307 generates data on a color chart and setting values including reference values and a patch layout. The color chart and the setting values are generated depending on a purpose, for example, a case where calibration of a sheet is performed, a case where a profile targeting color standard is created, or a case where color verification is performed.

In step S1101, the colorimetry processing control unit 300 receives a connection request from the color management system 103.

In step S1102, after communication with the color management system 103 is established, the colorimetry processing control unit 300 acquires the setting values generated in step S1100 from the color management system 103.

With the above-described configuration, it is possible to create the color chart and the setting values suitable for the image forming apparatus and a use case, and to perform color verification and automatic determination of the row on which the colorimetry has been performed, by using the color chart and the setting values.

A third exemplary embodiment is described. In the first exemplary embodiment, an example in which one colorimetric value can be acquired for one color patch from the spectrophotometer 107 is described. However, some of the spectrophotometers in recent years return a plurality of colorimetric values in single reading. This is realized by a function of the spectrophotometer that acquires the plurality of colorimetric values while changing a light source of mFactor in reading. Accordingly, in the third exemplary embodiment, a configuration in which, in a case where a plurality of colorimetric values can be acquired for one color patch from the spectrophotometer 107, a suitable colorimetric value is specified, and then, a row is determined is described. A basic configuration according to the third exemplary embodiment is the same as the basic configuration according to the first exemplary embodiment. Accordingly, only differences are described.

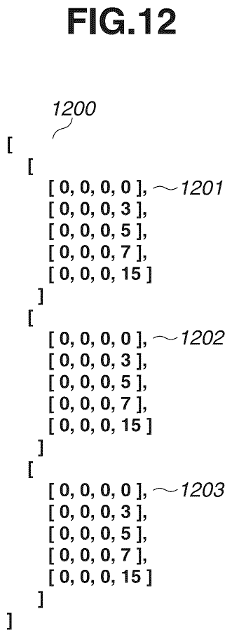

FIG. 12 illustrates examples of colorimetric values acquired from the spectrophotometer 107. In a manner similar to FIG. 7, the user performs colorimetry on a row of the color chart by using the spectrophotometer 107, data on colorimetry is transmitted from the spectrophotometer 107 to the colorimetric value acquisition unit 302, and the colorimetric value acquisition unit 302 creates the colorimetric values.

A colorimetric value 1200 includes three colorimetric values. A colorimetric value 1201 is a colorimetric value in a case where mFactor is M0. A colorimetric value 1202 is a colorimetric value in a case where mFactor is M1. A colorimetric value 1203 is a colorimetric value in a case where mFactor is M2. In other words, in this example, three measurement illumination conditions are provided, and colorimetric values under the respective conditions are acquired.

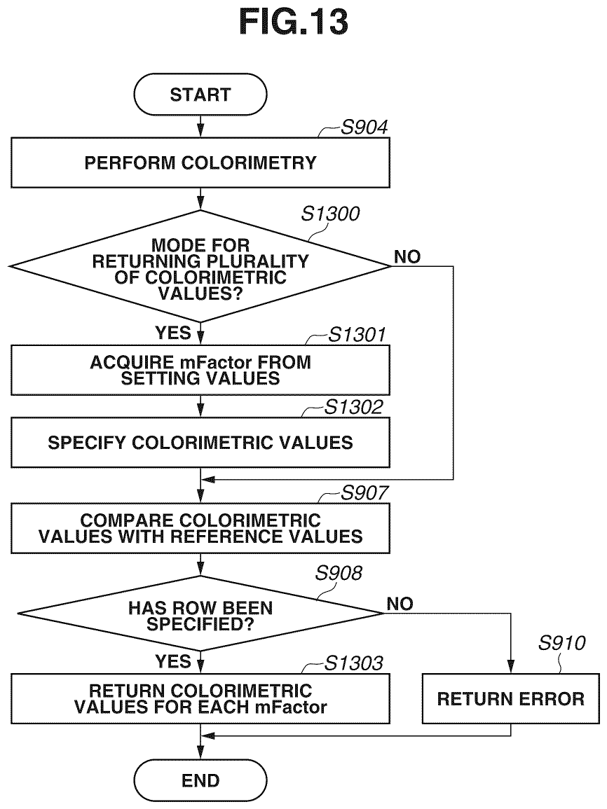

FIG. 13 is a flowchart illustrating a flow from the colorimetry of the color chart to the row determination in a case where the plurality of colorimetric values can be acquired from the spectrophotometer. The processing in the flowchart has the basic configuration same as the processing in the flowchart illustrated in FIG. 9. Accordingly, only differences are described. The processing in the flowchart is processing in a case where acquisition of the plurality of colorimetric values from the spectrophotometer 107 is designated based on the setting values illustrated in FIG. 5 (for example, colorimetry mode 508).

In step S1300, the colorimetry processing control unit 300 checks the colorimetry mode of the spectrophotometer 107, and determines whether the colorimetry mode is a mode for returning a plurality of colorimetric values. In a case where the colorimetry mode is a mode for returning a plurality of colorimetric values for one color patch (YES in step S1300), the processing proceeds to step S1301. In a case where the colorimetry mode is a mode not for returning a plurality of colorimetric values (NO in step S1300), the processing proceeds to step S907.

In step S1301, the colorimetry processing control unit 300 acquires mFactor supposed for the reference values, from the setting values.

In step S1302, the colorimetry processing control unit 300 specifies the colorimetric values used for row determination processing from the plurality of colorimetric values based on mFactor supposed for the reference values. For example, in a case where mFactor supposed for the reference values is M0, only the colorimetric values corresponding to M0 are extracted from the acquired colorimetric values, and the extracted colorimetric values are used for row determination.

In step S1303, the colorimetry processing control unit 300 returns the plurality of colorimetric values acquired from the spectrophotometer 107, the row number, and the colorimetric direction, to the color management unit 305 through the colorimetry screen unit 304.

With the above-described configuration, even in the case where the plurality of colorimetric values can be acquired for one color patch from the spectrophotometer, it is possible to specify the colorimetric values used for the row determination from the plurality of colorimetric values, and to specify the row on which the colorimetry has been performed in the color chart.

A fourth exemplary embodiment is described. In the first exemplary embodiment, an example in which colors of the same type are arranged in each of the rows of the color chart as illustrated in FIG. 6 is described. In a case where colors of different types are randomly arranged in the patches as with the color chart illustrated in FIG. 10, the row may not be distinctively distinguished unlike FIG. 6. In the fourth exemplary embodiment, row determination processing in the case where the patches of the color chart are randomly arranged is described.

A basic configuration according to the fourth exemplary embodiment is the same as the basic configuration according to the first exemplary embodiment. Accordingly, only differences are described.

In the case where the patches are randomly arranged, the color chart generation unit 307 arranges one or more patches among the patches arranged in each of the rows of the color chart, as a row distinction patch in each of the rows. It is sufficient for the row distinction patch to enable distinction of the row. For example, a color not overlapped among the rows is adopted from colors used in the entire color chart. When such a row-specific patch for uniquely distinguishing a row is arranged in each of the rows and is read, the row can be uniquely and distinctively specified even when the color patches are randomly arranged. Even when the color patches are randomly arranged, the row can be determined with the configuration according to the first exemplary embodiment, but providing the patch for uniquely distinguishing a row makes it possible to further enhance accuracy.

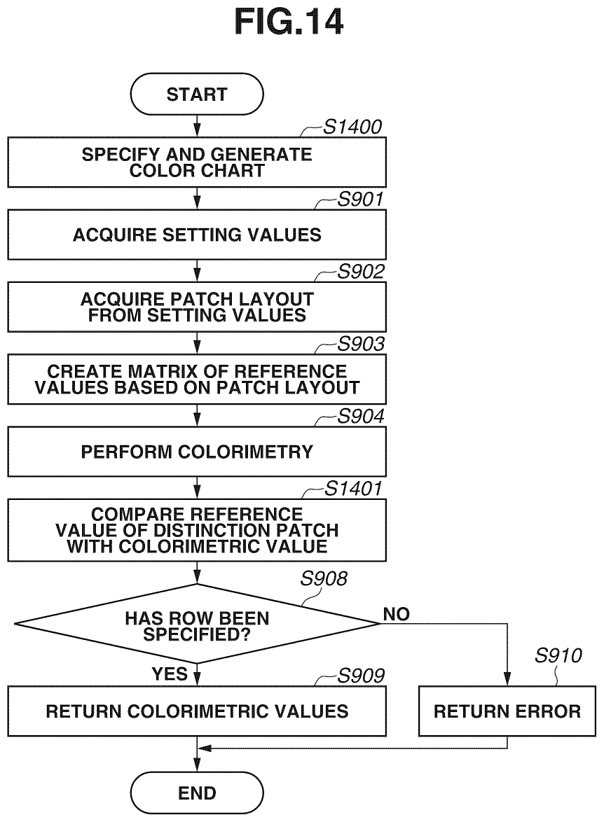

FIG. 14 is a flowchart illustrating a flow of the row determination in a case where the row distinction patch is arranged in each of the rows of the color chart. As in the first exemplary embodiment, the processing in the flow chart is started in a case where a colorimetry start instruction is issued by a user on a screen (not illustrated). The processing in the flowchart has the basic configuration same as the processing in the flowchart illustrated in FIG. 9. Accordingly, only differences are described.

In step S1400, when arranging the patches in the rows in the color chart, the color chart generation unit 307 arranges one or more patches for uniquely distinguishing a row, in each of the rows. The reference values of the one or more patches for uniquely distinguishing a row are stored in the storage unit and are used in row determination.

In step S1401, the row determination unit 301 compares the reference values and the colorimetric values. At this time, the row determination unit 301 compares the reference values of the row distinction patches and the colorimetric values, to specify the row on which the user has performed the colorimetry. For example, in a case where differences between the reference values and the colorimetric values of the row distinction patches are within a range of an allowable value, the row can be specified. The arrangement positions of the row distinction patches in each of the rows may be described in, for example, the setting values.

With the above-described configuration, even in the case where the patches of the color chart are randomly arranged, arranging the row distinction patch in each of the rows makes it possible to distinctively specify the row on which the colorimetry has been performed in the color chart.

A fifth exemplary embodiment is described. In the first exemplary embodiment, an example in which colors of the same type are arranged in each of the rows of the color chart is described. In the case where colors of different types are randomly arranged in the patches as with the color chart illustrated in FIG. 10, the row may not be distinctively distinguished. In a case where colors of the same type are arranged but adjustment of the image forming apparatus is not performed, erroneous determination of the row may occur. In the fifth exemplary embodiment, an example in which the row distinction patches are arranged at both ends in each of the rows, and the row is determined by reading the patches is described. A basic configuration according to the fifth exemplary embodiment is the same as the basic configuration according to the first exemplary embodiment. Accordingly, only differences are described.

For example, in the color chart illustrated in FIG. 6 or FIG. 10, the row distinction patches are arranged at both ends in each of the rows. Colors not used in the color chart are used for the patches. In addition, the colors of the patches are different among the rows. Different colors may be designated at both ends, and reading start and reading end of the row may be distinguished. A starting patch indicating start and an ending patch indicating end arranged at both ends in each of the rows are transmitted to the row determination unit 301. As a result, the row determination unit 301 can distinguish the patches and determine the row.

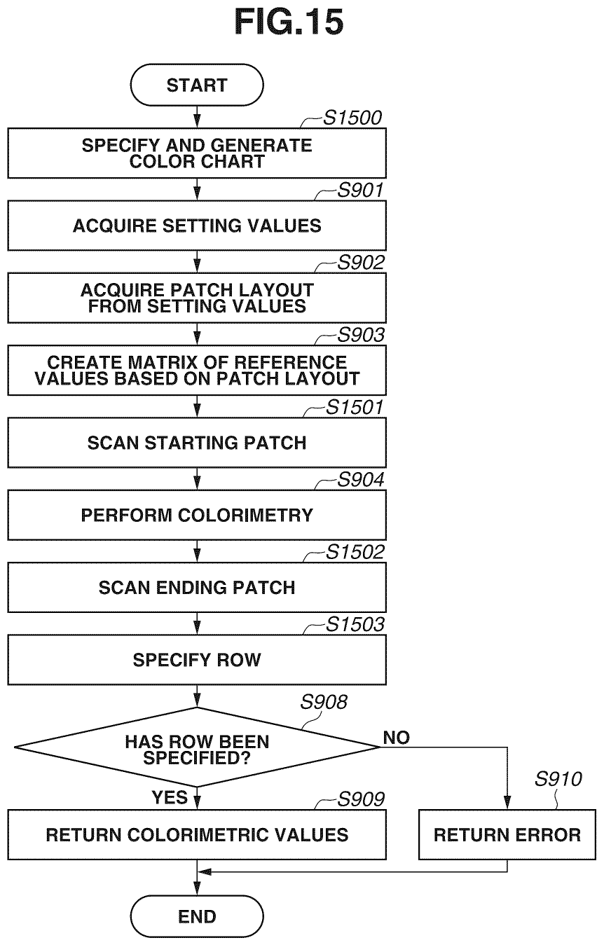

FIG. 15 is a flowchart illustrating a flow of row determination in the case where the row distinction patches are arranged at both ends in each of the rows of the color chart. As in the first exemplary embodiment, processing in the flowchart is started in a case where a colorimetry start instruction is issued by a user on a screen (not illustrated).

The processing in the flowchart has the basic configuration same as the processing in the flowchart illustrated in FIG. 9. Accordingly, only differences are described.

In step S1500, the color chart generation unit 307 arranges a starting patch and an ending patch for row distinction at respective ends in each of the rows configuring the color chart. Reference values of the starting patch and the ending patch are stored in the storage unit and are used for row determination.

In step S1501, the colorimetric value acquisition unit 302 reads any of the row distinction patches arranged at the ends of the rows. In a case where one of the patches arranged at both ends is read, the read patch is regarded as the starting patch, and reading of the corresponding row is started.

In step S1502, the colorimetric value acquisition unit 302 reads any of the row distinction patches arranged at both ends of the rows. In a case where the patch at the other end is read, the read patch is regarded as the ending patch, and reading of the corresponding row is ended.

In step S1503, the row determination unit 301 checks the patches read in steps S1501 and S1502, thereby specifying the row.

As described above, the row distinction patches are arranged at both ends in each of the rows, which makes it possible to specify the row on which the colorimetry has been performed in the color chart.

One or more of the above-described first to fifth exemplary embodiments may be combined.

A storage medium storing program codes of software realizing the above-described functions may be supplied to a system or an apparatus, and a computer (central processing unit (CPU), microprocessor unit (MPU), or the like) of the system or the apparatus may read out and execute the program codes stored in the storage medium. In this case, the program codes themselves read out from the storage medium realize the functions of the above-described exemplary embodiments, and the storage medium storing the program codes is included in the above-described apparatus.

As the storage medium for supplying the program codes, for example, a flexible disk, a hard disk, an optical disc, a magnetooptical disc, a compact disc read only memory (CD-ROM), a compact disc recordable (CD-R), a magnetic tape, a nonvolatile memory card, a ROM, and a digital versatile disc (DVD) can be used.

The above-described functions may be realized not only by executing the program codes read out by the computer, but also by performing some or all of the actual processing by an OS operating on the computer based on an instruction from the program codes.

The program codes read out from the storage medium are written in a memory provided in a function extension board inserted into the computer or a function extension unit connected to the computer.

Based on an instruction from the program codes, a CPU provided in the function extension board or the function extension unit may perform some or all of the actual processing to realize the above-described functions.

### Other Embodiments

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC) or the like) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU), or the like) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to exemplary embodiments, it is to be understood that the disclosure is not limited to the disclosed exemplary embodiments. The scope of the following claims is to be accorded the broadest interpretation so as to encompass all such modifications and equivalent structures and functions.

This application claims the benefit of priority from Japanese Patent Application No. 2023-192282, filed Nov. 10, 2023, which is hereby incorporated by reference herein in its entirety.

What is claimed is:

1. A method of controlling an information processing apparatus, the method comprising:
acquiring reference values of patches of a color chart and information on layout of the patches;
acquiring colorimetric values obtained by performing colorimetry on the color chart by a spectrophotometer; and
specifying a row of the color chart on which a user has performed colorimetry based on the acquired reference values of the patches, the acquired information on the layout of the patches, and the acquired colorimetric values.

2. The method according to claim 1, further comprising displaying the specified row to be identified by the user.

3. The method according to claim 1, wherein the patches are arranged in each of rows to enable unique specification of each of the rows in the color chart.

4. The method according to claim 1, wherein a patch for uniquely specifying a row in the color chart is arranged in each of the rows.

5. The method according to claim 1, wherein the row of the color chart on which the user has performed colorimetry is specified by comparing the acquired reference values of the patches and the acquired colorimetric values.

6. The method according to claim 1, wherein color verification is performed by comparing the acquired reference values of the patches and the acquired colorimetric values.

7. The method according to claim 1, wherein, in the specifying, a direction in which the user has performed colorimetric is further specified.

8. The method according to claim 1, wherein the information on the layout includes a number of rows and a number of columns.

9. The method according to claim 1, further comprising notifying an error in a case where the row is not specified.

10. The method according to claim 1, wherein, in a case where a plurality of colorimetric values is acquired for one patch, a colorimetric value to be used is selected from the plurality of colorimetric values, and the row is specified.

11. The method according to claim 1, wherein, in the color chart, the patches are arranged by using four color components of cyan, magenta, yellow, and black, the color components being different for respective rows.

12. A non-transitory computer-readable storage medium that stores one or more programs including instructions, which when executed by one or more processors of the information processing apparatus, cause the information processing apparatus to perform a control method, the control method comprising:
acquiring reference values of patches of a color chart and information on layout of the patches;
acquiring colorimetric values obtained by performing colorimetry on the color chart by a spectrophotometer; and
specifying a row of the color chart on which a user has performed colorimetry based on the acquired reference values of the patches, the acquired information on the layout of the patches, and the acquired colorimetric values.

13. An information processing apparatus comprising at least one processor and at least a memory coupled to the at least one processor and having instructions stored thereon, and when executed by the at least one processor, acting as:
a first acquisition unit configured to acquire reference values of patches of a color chart and information on layout of the patches;
a second acquisition unit configured to acquire colorimetric values obtained by performing colorimetry on the color chart by a spectrophotometer; and
a specification unit configured to specify a row of the color chart on which a user has performed colorimetry based on the reference values of the patches and the information on the layout of the patches acquired by the first acquisition unit, and the colorimetric values acquired by the second acquisition unit.
